(19) United States
(12) Patent Application Publication
(10) Pub. No.: US 2025/0231315 A1
(43) Pub. Date: Jul. 17, 2025

(54) MACHINE LEARNING BASED PORE BODY TO PORE THROAT SIZE TRANSFORMATION FOR COMPLEX RESERVOIRS

(71) Applicants: Halliburton Energy Services, Inc., Houston, TX (US); Saudi Arabian Oil Company, Dhahran (SA)

(72) Inventors: Wei Shao, Houston, TX (US); Songhua Chen, Houston, TX (US); Shouxiang Mark Ma, Dhahran (SA); Gabor Hursan, Dhahran (SA); Abdullah A Alakeely, Dhahran (SA)

(73) Assignees: Halliburton Energy Services, Inc., Houston, TX (US); Saudi Arabian Oil Company, Dhahran (SA)

(21) Appl. No.: 18/414,685

(22) Filed: Jan. 17, 2024

(51) Int. Cl. G01V 3/38; E21B 44/00; G01V 3/32

(52) U.S. Cl. CPC G01V 3/38; E21B 44/00; G01V 3/32; E21B 2200/20; E21B 2200/22

(57) ABSTRACT

A computer-implemented method is provided. The computer-implemented method can include receiving one or more input NMR measurements at a first neural network; transforming the one or more input NMR measurements to a predicted pore throat size distribution or one or more predicted pore throat size parameters; receiving the predicted pore throat size distribution or the one or more predicted pore throat size parameters at a second neural network; transforming the predicted pore throat size distribution or the one or more predicted pore throat size parameters to a predicted NMR T₂ distribution or one or more predicted NMR T₂ parameters; and applying one or more physics based equations to the predicted NMR T₂ distribution or the one or more predicted NMR T₂ parameters to forward model the predicted NMR T₂ distribution or the one or more predicted NMR T₂ parameters to one or more simulated NMR measurements.

### FIELD

The present disclosure relates generally to systems and methods for transforming nuclear magnetic resonance (NMR) measurements of a sample to a pore throat size distribution and an NMR T₂ distribution using a multi-level machine learning model.

### BACKGROUND

In many oil drilling operations, pore body and pore throat size are highly important for determining where to drill. For example, pore body and pore throat size can elucidate the oil and water flow characteristics and storage capacity of the formation in the earth at a certain location. By determining the reservoir fluid storage capacity and rock permeability in the ground formation in in-situ conditions, decisions on where and how far to drill and perforation can be optimized to ensure that expensive oil service equipment is properly utilized and production of petroleum is maximized.

### BRIEF DESCRIPTION OF THE DRAWINGS

Implementations of the present technology will now be described, by way of example only, with reference to the attached figures, wherein:

FIG. 1A is a schematic diagram of an example logging while drilling (LWD) wellbore operating environment in accordance with various aspects of the disclosure;

FIG. 1B is a diagram of an example downhole environment having tubulars, in accordance with various aspects of the disclosure;

FIG. 2A illustrates various petrophysical parameters that effect the transformation of NMR T₂ distributions to pore throat size distributions;

FIG. 2B illustrates mapping NMR relaxation time distributions to MICP pore throat size distributions as uniformly linear transformation in reservoirs with simple type rock formations;

FIGS. 3A-3B illustrate an example of the non-linearity of the correlation between NMR T₂ distributions (FIG. 3A) and the corresponding pore throat size distributions (FIG. 3B) of five carbonate core samples;

FIG. 4 illustrates a flow chart for producing training data for a multi-level machine learning module using a single core data augmentation approach;

FIGS. 5A-5C illustrate training data for a single core data augmentation method where FIG. 5A illustrates NMR T₂ distribution in ms for the single core data, FIG. 5B illustrates echo trains with added levels of noise, and FIG. 5C illustrates NMR T₂ distributions for the echo trains with added levels of noise;

FIG. 6 illustrates a flow chart for producing training data for a multi-level machine learning module using a multiple core data augmentation approach;

FIGS. 7A-7C illustrate training data for a multiple core augmentation method where FIG. 7A illustrates NMR T₂ for the multiple core data in ms, FIG. 7B illustrates echo trains with added levels of noise, and FIG. 7C illustrates NMR T₂ distributions for the echo trains with added levels of noise;

FIG. 8 illustrates a two level machine learning model;

FIG. 9 illustrates a flow chart of a computer-implemented method for transforming NMR measurements of a sample to a pore throat distribution and an NMR T₂ distribution using a multi-level machine learning model;

FIG. 10 illustrates an exemplary neural network;

FIG. 11 is a diagram illustrating an example of a system for implementing certain aspects of the present disclosure;

FIG. 12A illustrates multi-level machine learning training results for NMR T₂ distributions;

FIG. 12B illustrates multi-level machine learning training results for pore throat size distributions corresponding to the NMR T₂ distributions of FIG. 12A;

FIG. 13 illustrates the total porosities predicted by the multi-level machine learning model as compared to the raw data;

FIG. 14A illustrates multi-level machine learning test results of a sample with single core data augmentation for NMR T₂ distributions;

FIG. 14B illustrates multi-level machine learning test results of a sample with single core data augmentation for pore throat size distributions;

FIG. 15 illustrates the total porosities predicted by the multi-level machine learning model as compared to the raw data;

FIG. 16A illustrates multi-level machine learning test results of a sample with three core data augmentation for NMR T₂ distributions;

FIG. 16B illustrates multi-level machine learning test results multi-level machine learning test results of a sample with three core data augmentation for pore throat size distributions; and

FIG. 17 illustrates the total porosities predicted by the multi-level machine learning model as compared to the raw data.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Disclosed herein are systems and methods for transforming nuclear magnetic resonance (NMR) measurements of a sample to a pore throat size distribution and an NMR T₂ distribution using a multi-level machine learning model. The transformation of NMR relaxation time distributions, such as NMR T₂ distributions, to mercury injection capillary pressure (MICP) pore throat size (PTS) distributions is affected by multiple measurement parameters and formation attributes (rock material distributions). The systems and methods disclosed herein utilize a multi-level machine learning model to map NMR T₂ distributions to MICP PTS. NMR echo trains are used as inputs to the multi-level machine learning model while NMR T₂ distributions and MICP PTS are the outputs. The multi-level machine learning model can utilize physics equations to additionally output simulated NMR echo trains to impose physics constraints for training the machine learning model and providing uncertainty determinations of the machine learning model predictions. In at least one example, the present disclosure relates to a first neural network having NMR measurements as inputs and a predicted pore throat size distribution as an output and a second neural network having the predicted pore throat size distribution as the input and a predicted NMR T₂ distribution as the output.

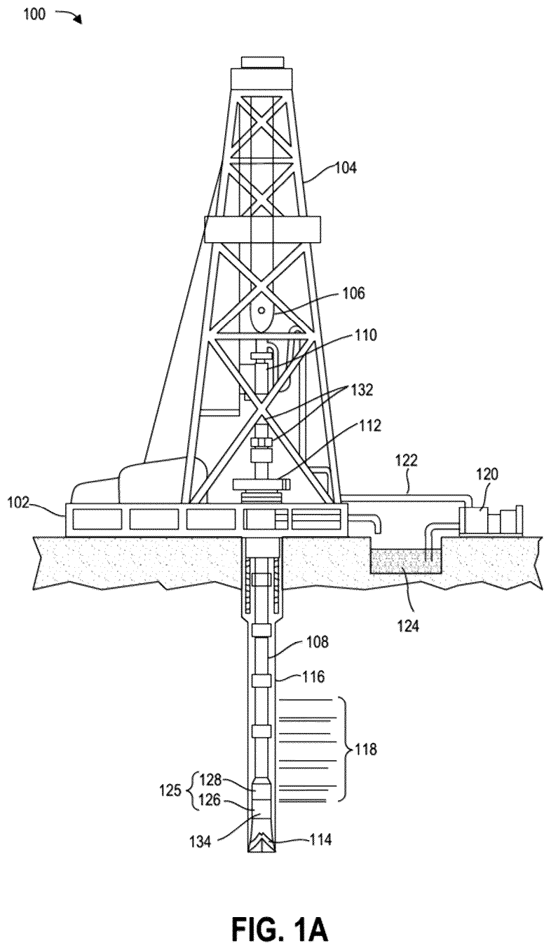

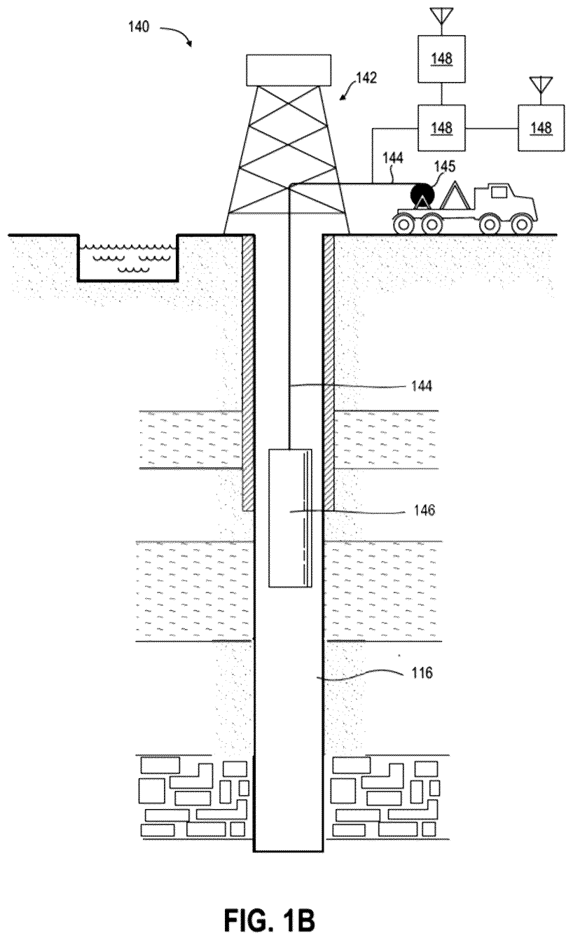

FIG. 1A is a schematic diagram of an example logging while drilling (LWD) operating environment of a well site, in accordance with various aspects of the disclosure.

In some aspects, a drilling arrangement is shown that exemplifies a LWD configuration in a wellbore drilling scenario 100. The LWD typically incorporates sensors that acquire formation data. The drilling arrangement of FIG. 1A also exemplifies measurement while drilling (MWD) and utilizes sensors to acquire data from which the wellbore's path and position in three-dimensional space may be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 may be connected to the lower end of the drill string 108. As the drill bit 114 rotates, the drill bit 114 creates a wellbore 116 that passes through one or more subterranean formations 118. A pump 120 circulates drilling fluid through a supply pipe 122 to top drive 110, down through the interior of the drill string 108, and out orifices in the drill bit 114 into the wellbore. The drilling fluid returns to the surface via the annulus around the drill string 108, and into a retention pit 124. The drilling fluid transports cuttings from the wellbore 116 into the retention pit 124 and the drilling fluid's presence in the annulus aids in maintaining the integrity of the wellbore 116. Various materials may be used for drilling fluid, including oil-based fluids and water-based fluids.

In some aspects, one or more logging tools 126 may be integrated into the bottom-hole assembly 125 near the drill bit 114. As the drill bit 114 extends the wellbore 116 through the subterranean formations 118, logging tools 126 collect measurements relating to various formation properties as well as the orientation of the tool and various other drilling conditions. In some cases, the logging tools interface with various sensors and equipment. The bottom-hole assembly 125 may also include a telemetry sub 128 to transfer measurement data to a surface receiver 132 and to receive commands from the surface. In at least some cases, the telemetry sub 128 communicates with a surface receiver 132 using mud pulse telemetry. In some instances, the telemetry sub 128 does not communicate with the surface, but rather stores logging data for later retrieval at the surface when the logging assembly is recovered.

Each of the logging tools 126 may include one or more tool components spaced apart from each other and communicatively coupled by one or more wires and/or another communication arrangement. The logging tools 126 may also include one or more computing devices communicatively coupled with one or more of the tool components. The one or more computing devices may be configured to control or monitor the performance of the tool, process logging data, and/or carry out one or more aspects of the methods and processes of the present disclosure.

In at least some instances, one or more of the logging tools 126 may communicate with a surface receiver 132 by a wire, such as a wired drill pipe. In other cases, the one or more of the logging tools 126 may communicate with a surface receiver 132 by wireless signal transmission, such as ground penetrating radar. In at least some cases, one or more of the logging tools 126 may receive electrical power from a wire that extends to the surface, including wires extending through a wired drill pipe.

In some aspects, a collar 134 is a frequent component of a drill string 108 and generally resembles a very thick-walled cylindrical pipe, typically with threaded ends and a hollow core for the conveyance of drilling fluid. In some cases, multiple collars 134 may be included in the drill string 108 and are constructed and intended to be heavy to apply weight on the drill bit 114 to assist the drilling process. Because of the thickness of the collar's wall, pocket-type cutouts or other type recesses may be provided into the collar's wall without negatively impacting the integrity (strength, rigidity, and the like) of the collar 134 as a component of the drill string 108.

FIG. 1B is a diagram of an example downhole environment having tubulars in accordance with various aspects of the disclosure. In some aspects, an example system 140 is depicted for conducting downhole measurements after at least a portion of a wellbore has been drilled and the drill string removed from the well. A downhole tool is shown having a tool body 146 to perform logging, measurements, and/or other operations. For example, instead of using the drill string 108 of FIG. 1A to lower a tool body 146, which may contain sensors and/or other instrumentation for detecting and logging nearby characteristics and conditions of the wellbore 116 and surrounding formations, a wireline conveyance 144 may be used.

The tool body 146 may be lowered into the wellbore 116 by wireline conveyance 144. The wireline conveyance 144 may be anchored in the drill rig 142 or by a portable device such as a truck 145. The wireline conveyance 144 may include one or more wires, slicklines, cables, and/or the like, as well as tubular conveyances such as coiled tubing, joint tubing, or other tubulars.

The wireline conveyance 144 provides power and support for the tool, as well as enabling communication between processing systems 148 on the surface. In some examples, the wireline conveyance 144 may include electrical and/or fiber optic cabling for performing any communications. The wireline conveyance 144 is sufficiently strong and flexible to tether the tool body 146 through the wellbore 116, while also permitting communication through the wireline conveyance 144 to one or more of the processing systems 148, which may include local and/or remote processors. In some cases, power may be supplied via the wireline conveyance 144 to meet the power requirements of the tool. For slickline or coiled tubing configurations, power may be supplied downhole with a battery or via a downhole generator.

The systems and methods described herein can be used to determine the locations to drill in accordance with the equipment described in FIGS. 1A-1B. The systems and methods provide more accurate NMR T₂ distributions and MICP PTS, thereby allowing for more accurate, efficient, and effective drilling methods.

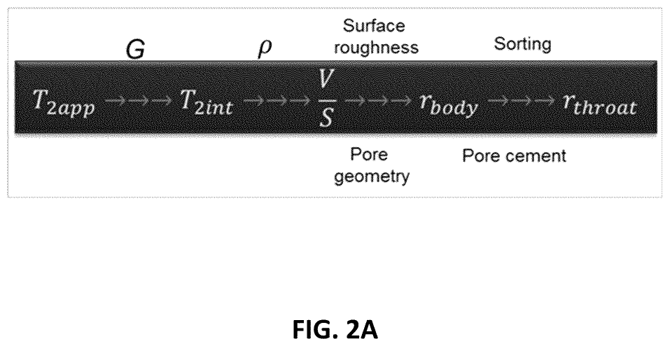

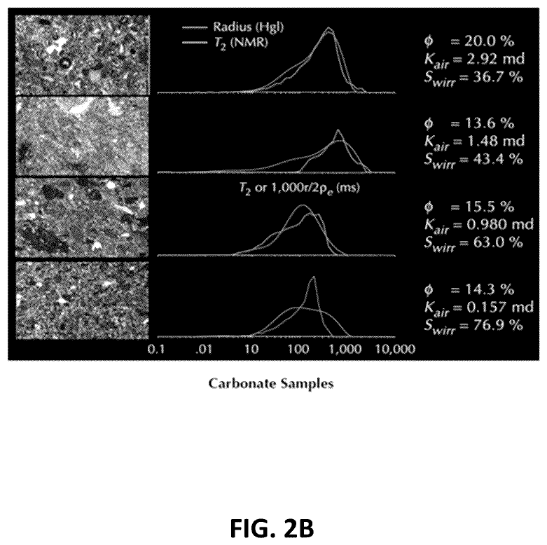

FIG. 2A illustrates parameters effecting the transformation of NMR T₂ distributions to MICP PTS distributions. For example, the parameters effecting the transformation can include the gradient (G), the surface relaxivity (ρ), surface roughness, pore geometry, pore cement, sorting, amongst other parameters.

As illustrated in FIG. 2B, for reservoirs with relatively simple rock type distributions, such as sandstone formations, the effects of the parameters on mapping of NMR T₂ distributions to MICP PTS distributions can be considered uniformly linear.

For carbonate reservoirs, the parameters can be highly non-linear and heterogenous. For example, the surface relaxivity (ρ) can be highly inhomogeneous due to complexities of the minerology. Also, the mapping of V/S (volume to surface area) to the radius of the pore bodies are subject to the grain and pore shapes, as well as the surface roughness. The mapping of NMR pore body size (e.g., NMR T₂ distributions) to MICP pore throat size is further complicated by grain sorting and pore cementation. The transformation is further complicated by the chemical processes, such as dissolution and recrystallization.

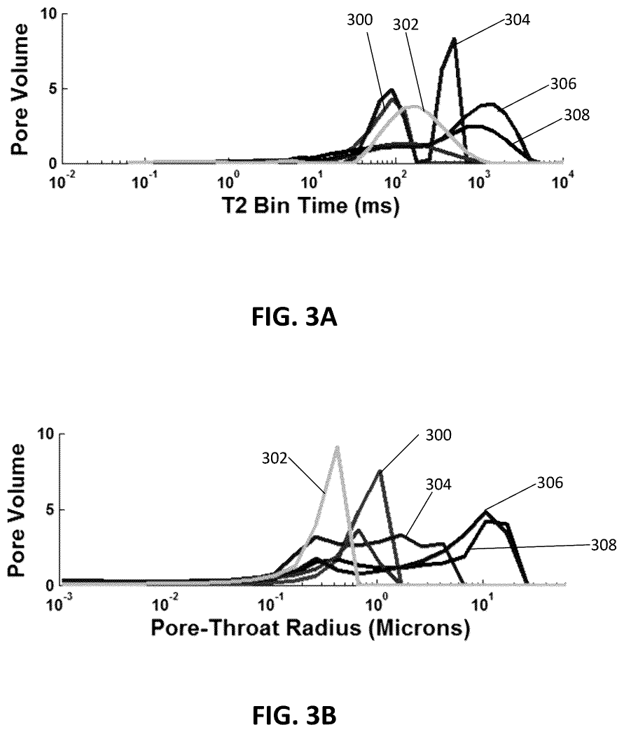

FIG. 3A illustrates NMR T₂ distributions in five carbonate core samples (e.g., first sample 300, second sample 302, third sample 304, fourth sample 306, and fifth sample 308). FIG. 3B illustrates the corresponding pore throat size distributions of the first sample 300, second sample 302, third sample 304, fourth sample 306, and fifth sample 308. As illustrated, the NMR T₂ distributions and corresponding pore throat size distributions are highly non-linear. Capturing the non-linear effects in transforming NMR T₂ distributions to pore throat size distributions is often difficult to do in analytical form.

A multi-level machine learning model can be used to transform NMR measurements (e.g., NMR echo trains) into MICP PTS distributions and NMR T₂ distributions. The multi-level machine learning model can approximate the highly non-linear and heterogenous relationship between NMR relaxation time distributions (NMR T₂ distributions) and MICP PTS distributions.

Typically, there is not a significant amount of training data available for modeling the transformation of NMR relaxation time distributions to MICP PTS distributions. Core data is often used as ground truth for developing and validating ML based petrophysical interpretation models. However, the amount of core data is often limited due to cost and time constraints. Further, there is a large amount of uncertainty within NMR measurements. This uncertainty is propagated into NMR relaxation time distributions through inversion, such as NMR T₂ distributions. The uncertainty can be caused by many factors including, but not limited to, NMR signal to noise ratio, regularization schemes and parameters for NMR inversion, and NMR data acquisition schemes.

The systems and methods described herein include data augmentation methods for providing training data for the multi-level machine learning module. The data augmentation methods can include ensembling, augmentation with different levels of noise, or ensembling and augmentation with different levels of noise collectively. The data augmentation methods can include single core data augmentation methods and multiple core data augmentation methods.

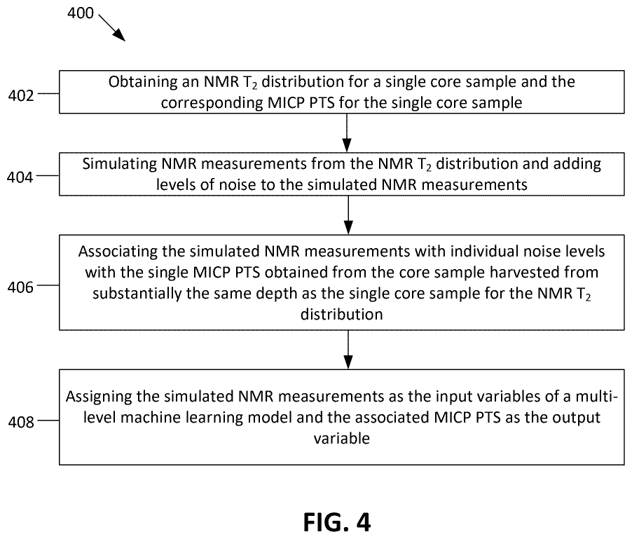

FIG. 4 illustrates a single core data augmentation method 400. The single core data augmentation method 400 can begin by obtaining a core sample. At block 402, an NMR T₂ distribution can be obtained for a single core sample. At block 404, the single core data augmentation method 400 can include simulating NMR measurements (e.g., echo responses) from the NMR T₂ distribution and adding levels of noise to the simulated NMR measurements. The NMR T₂ distribution can be simulated (e.g., forward modeled) to simulate NMR echo responses with added levels of noise. In some examples, the added levels of noise can be noise having signal-to-noise ratios (SNR) of 5, 10, 15, and 20. In other examples, the added levels of noise can have SNRs of about less than 5, about 5 to about 10, about 10 to about 15, about 15 to about 20, about 20 to about 25, or more. Multiple levels of noise can be added to the simulated NMR echo response. At block 406, the single core data augmentation method 400 can include associating the simulated NMR measurements with individual noise levels with the single MICP PTS obtained from a core sample harvested from substantially the same depth as the single core sample for the NMR T₂ distribution. At block 408, the single core data augmentation method 400 can include assigning the simulated NMR measurements as the input variables of the multi-level machine learning model described herein. At block 408, the single core data augmentation method 400 can further include assigning the associated MICP PTS as the output variable of the multi-level machine learning model described herein.

The NMR T₂ distributions can be forward modeled using NMR 1D data acquisition schemes or NMR 2D data acquisition schemes with an assortment and combination of data acquisition parameters such as wait time (TW), inter-echo spacing (TE), the dynamic decay range described by number of echoes (NE) or NE*TE. In some examples, the wait time (TW) for an NMR 1D data acquisition scheme can be about 10000 milliseconds (ms), about 100 ms, and/or about 10 ms. The inter-echo spacing (TE) can be about 0.3 ms. The number of echoes (NE) can be about 2000, 200, or 20. Table 1 illustrates an example for NMR 1D data acquisition parameters.

TABLE 1
NMR Data Acquisition Parameters

| TW(ms) | TE (ms) | NE |
|---|---|---|
| 10000 | 0.3 | 2000 |
| 100 | 0.3 | 200 |
| 10 | 0.3 | 20 |

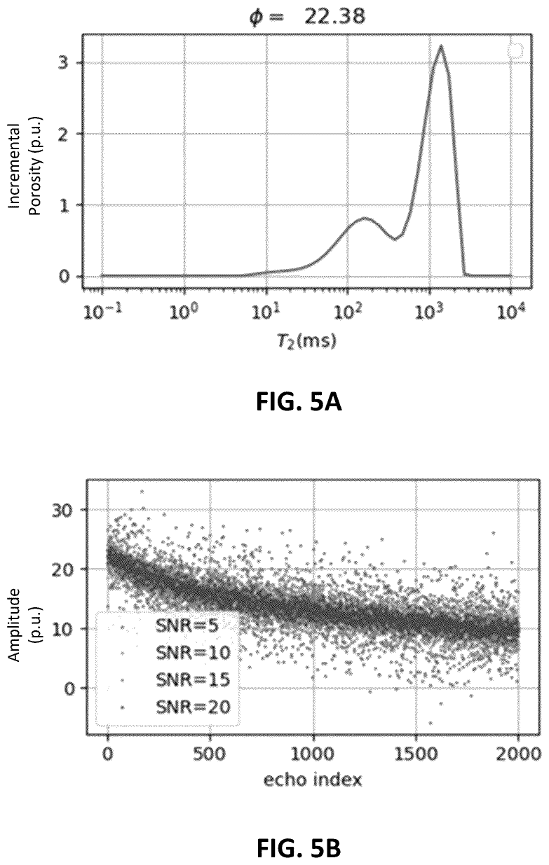

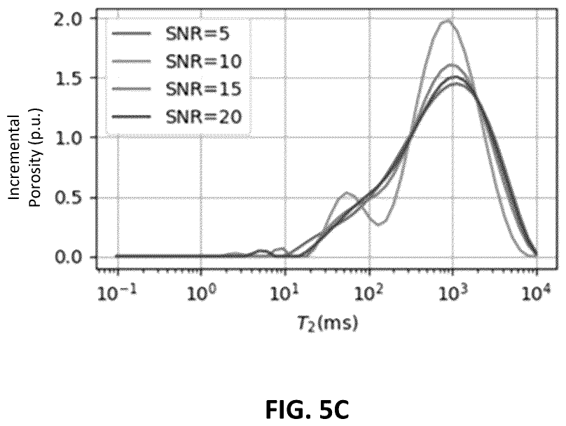

FIG. 5A illustrates the NMR T₂ distribution of the single core sample for the single core data acquisition method. FIG. 5B illustrates the echo responses for added levels of noise having SNRs of 5, 10, 15, and 20. FIG. 5C illustrates the NMR T₂ distributions for the added levels of noise having SNRs of 5, 10, 15, and 20. The porosity (ϕ) of the single core sample in FIGS. 5A-5C is 22.38.

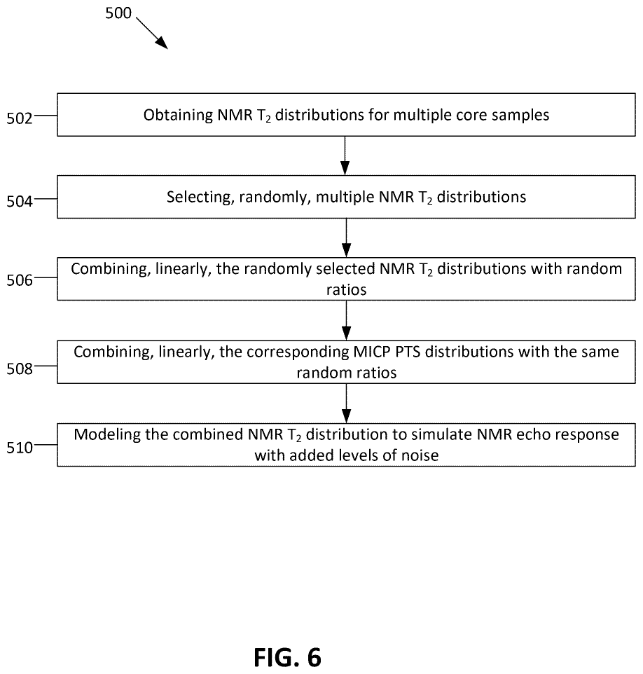

FIG. 6 illustrates a flow chart for a multiple core data augmentation method 500. At block 502, the multiple core data augmentation method 500 can include obtaining NMR T₂ distributions for multiple core samples. In some examples, multiple cores samples can include hundreds, thousands, millions, or more core samples. In an example, the core samples can be obtained from the same rock formation. In other examples, the core samples can be obtained from different rock formations.

At block 504, the multiple core data augmentation method 500 can include randomly selecting NMR T₂ distributions from the multiple core samples. At block 506, the multiple core data augmentation method 500 can include linearly combining the randomly selected NMR T₂ distributions with random weighting multiples on the member T₂ distributions forming the combined echo train (e.g., linearly combining the NMR T₂ distributions with random ratios). In some examples, linearly combining the randomly selected NMR T₂ distributions can include an ensembling method. At block 508, the multiple core data augmentation method 500 can include linearly combining the corresponding MICP PTS distributions with the same ratios as the linearly combined NMR T₂ distributions. At block 510, the multiple core data augmentation method 500 can include forward modeling the linearly combined NMR T₂ distribution to simulate NMR echo response (e.g., NMR echo trains) with added levels of noise. In some examples, the added levels of noise can have SNRs of 5, 10, 15, and 20. In another example, the added levels of noise can have SNRs of about less than 5, about 5 to about 10, about 10 to about 15, about 15 to about 20, about 20 to about 25, or more. In an example, the corresponding MICP PTS distribution can be the linearly combined MICP PTS distribution. Linearly combining the NMR T₂ distributions and MICP PTS distributions can include volumetrically combining the NMR T₂ distributions and the MICP PTS distributions.

The NMR T₂ distributions can be forward modeled using NMR 1D data acquisition schemes or NMR 2D data acquisition schemes. In some examples, the wait time (TW) for an NMR 1D data acquisition scheme can be about 10000 milliseconds (ms), about 100 ms, and/or about 10 ms. The inter-echo spacing (TE) can be about 0.3 ms. The NE can be about 2000, 200, or 20. Table 1 illustrates an example for NMR 1D data acquisition parameters.

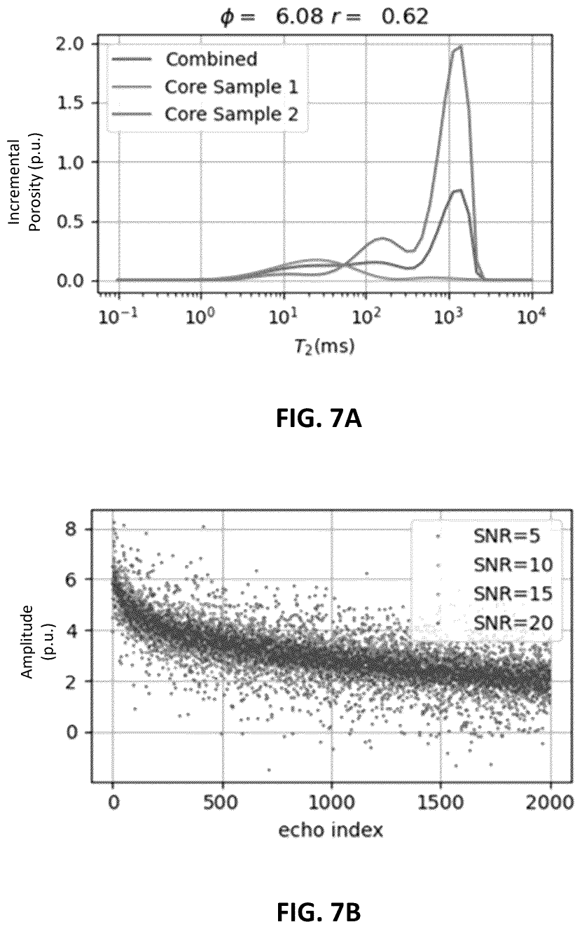

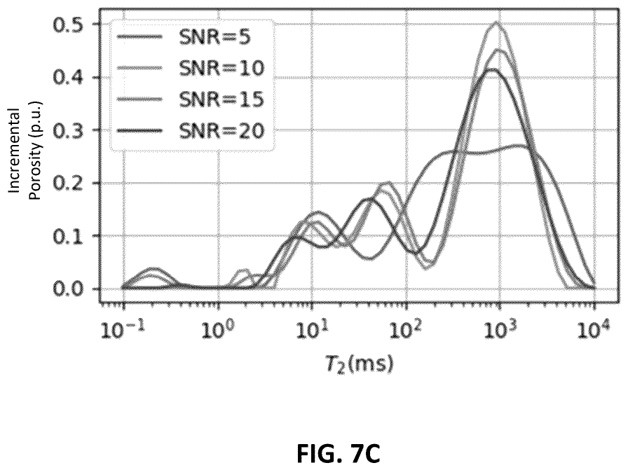

FIG. 7A illustrates the combined NMR T₂ distribution, and NMR T₂ distributions of two core samples for the multiple core data acquisition method. FIG. 7B illustrates the echo responses for added levels of noise having SNRs of 5, 10, 15, and 20. FIG. 7C illustrates the NMR T₂ distributions for the added levels of noise having SNRs of 5, 10, 15, and 20. The combined porosity (ϕ) of the multiple core samples in FIGS. 7A-7C is 6.08 and the ratio of the combined core samples is 0.62.

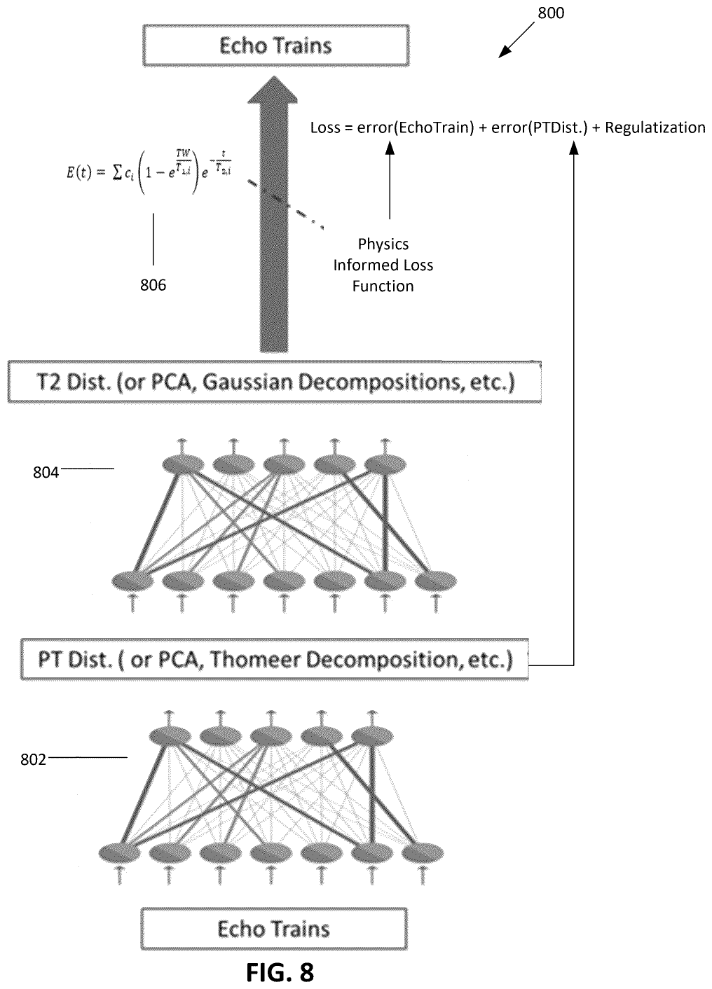

FIG. 8 is a diagram of a two-level machine learning model 800 that can be used in various aspects of the present disclosure. The two-level machine learning model 800 can be trained using the data augmentation methods described herein. The two-level machine learning model 800 can be physics informed and transform NMR T₂ distributions to MICP PTS. The first level 802 can be a deep neural network with at least one hidden layer, as described further herein. The second level 804 can be a deep neural network with at least one hidden layer, as described further herein. The inputs to the first level 802 can be NMR echo trains. The outputs of the first level can be predicted MICP PTS or MICP PTS dimension reduced representations, such as principal components (PCA), Thomeer decompositions, or Gaussian decompositions. The inputs to the second level 804 can be the outputs of the first level 802 (e.g., predicted MICP PTS or MICP PTS dimension reduced representations). The outputs of the second level 804 can be predicted NMR T₂ distributions or NMR T₂ dimension reduced representations, such as PCA, Thomeer decompositions, or Gaussian decompositions.

The two-level machine learning model 800 can also include a physics informed loss function 806 operable to forward model the predicted NMR T₂ distributions or dimension reduced representations from the second level 804 to simulate NMR responses (e.g., echo trains). The physics informed loss function 806 can include the mean square differences between the simulated echo trains and the echo trains input to the first level 802, a regularization term with 0^{th} or 2^{nd} order, and the mean square differences between the predicted MICP PTS and measured (and/or augmented) MICP PTS. The simulated echo trains can be calculated using Equation 1.

$$E ( t ) = \sum {c}_{i} ( 1 - {e}^{\frac{T W}{{T}_{1 , i}}} ) {e}^{- \frac{t}{{T}_{2 , i}}} \qquad ( Equation 1 )$$

The final outputs from the two-level machine learning model 800 can be predicted MICP PTS, predicted NMR T₂ distributions, and simulated NMR echo trains.

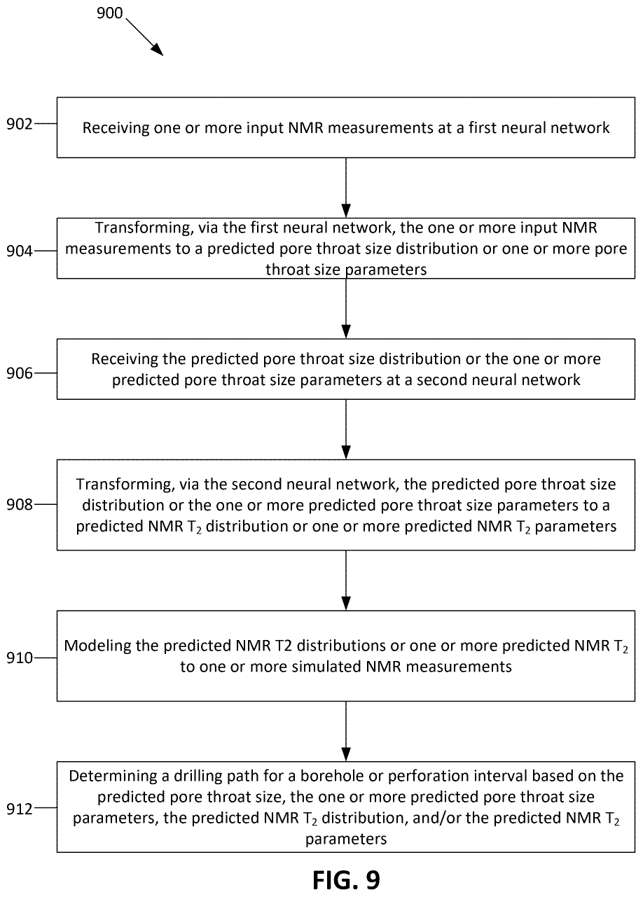

FIG. 9 illustrates a computer-implemented method 900 for using the multi-level machine learning model. At block 902, the computer-implemented method 900 can include receiving one or more input NMR measurements at a first neural network. The one or more input NMR measurements can be recorded in a time domain as echo trains by NMR instruments. The echo trains can be taken from rock formations to be analyzed for oil or other mineral content.

At block 904, the computer-implemented method can include transforming, via the first neural network, the one or more input NMR measurements to a predicted pore throat size distribution (e.g., MICP PTS) or one or more predicted pore throat size parameters. The one or more predicted pore throat size parameters can be dimension reduced representations such as principal components, Thomeer decompositions, or Gaussian decompositions. At block 906, the computer-implemented method can include receiving the predicted pore throat size distribution or the one or more predicted pore throat size distribution parameters at a second neural network. At block 908, the computer-implemented method can include transforming, via the second neural network, the predicted pore throat size distribution or the one or more predicted pore throat size parameters to a predicted NMR T₂ distribution or one or more predicted NMR T₂ parameters. The one or more predicted NMR T₂ parameters can be dimension reduced representations such as principal components, Thomeer decompositions, or Gaussian decompositions.

At block 910, the computer-implemented method 900 can include forward modeling the predicted NMR T₂ distributions or one or more predicted NMR T₂ parameters to one or more simulated NMR measurements (e.g., simulated NMR echo trains). The one or more simulated NMR measurements can be compared to the one or more input NMR measurements to determine an uncertainty of the multi-level machine learning model. Forward modeling the predicted NMR T₂ distributions or one or more predicted NMR T₂ parameters can include applying one or more physics based equations to the predicted NMR T₂ distribution or the one or more predicted NMR T₂ parameters to forward model the predicted NMR T₂ distribution or one or more predicted NMR T₂ parameters to one or more simulated NMR measurements. In an example, the one or more simulated NMR measurements can be NMR response recorded in a time domain as echo trains. The one or more physics based equations can include Equation 1. In some examples, the one or more physics based equations can be part of a loss function for optimizing the predicted pore throat size distribution, the one or more predicted pore throat size parameters, the predicted NMR T₂ distribution, and/or the one or more predicted NMR T₂ parameters. The loss function can include mean square differences between the one or more simulated NMR measurements and the one or more input NMR measurements, a regularization term having 0th or 2nd order, and mean square differences between the predicted pore throat size distribution and a measured pore throat size distribution.

The computer-implemented method 900 can further include training the multi-level machine learning model. Training the multi-level machine learning model can be accomplished using the data augmentation methods described herein. For example, training the multi-level machine learning model can include augmenting the one or more input NMR measurements with one or more noise contamination levels as measured in SNR. The corresponding pore throat size distribution for the one or more input NMR measurements can be constant (e.g., not modified with noise contamination levels). In some examples, the noise contamination levels have SNRs of 5, 10, 15, and 20. Other levels of noise contamination can be used.

Training the multi-level machine learning model can include randomly selecting and linearly combining one or more input variables with random ratios and linearly combining one or more target variables with the same random variables. If the one or more input variables and the one or more target variables have different additive basis, the one or more input variables or the one or more target variables can be converted such that the input variables and the output variables have the same additive basis. The one or more input variables can be NMR T₂ distributions and the one or more target variables can be pore throat size distributions. The linearly combined NMR T₂ distribution can be forward modeled to simulate NMR echo response with added noise contamination levels having SNRs of 5, 10, 15, and 20. The corresponding pore throat size distribution can be the linearly combined pore throat size distribution of the NMR T₂ distributions that were linearly combined. The NMR T₂ distributions can be forward modeled using NMR 1D acquisition schemes or NMR 2D acquisition schemes.

At block 912, the computer-implemented method 900 can include determining a drilling path for a borehole or perforation interval based on the predicted pore throat size, the one or more predicted pore throat size parameters, the predicted NMR T₂ distribution, and/or the predicted NMR T₂ parameters. The computer-implemented method 900 can further include determining a total porosity and partial porosity of the sample (i.e., the sample that provided the one or more NMR measurements) from the predicted NMR T₂ distribution and the predicted pore throat size distribution. The predicted NMR T₂ distribution, the predicted pore throat size distribution, the one or more predicted NMR T₂ parameters, the one or more predicted pore throat size parameters, the total porosity, and/or the partial porosity of the sample can be used to determine the contents of the sample and thereby the rock formation from which the sample was obtained. Further, the contents of the sample and the rock formation can be used to determine whether to drill for oil in the location, how far to drill, and where to drill thereby providing more cost effective drilling operations.

The multi-level machine learning model performance can be validated by determining the total and partial porosities from the predicted NMR T₂ distributions and MICP PTS. These total and partial porosities can be compared to total and partial porosities calculated using known methods (e.g., NMR inversion) as an indicator of the multi-level machine learning model's performance.

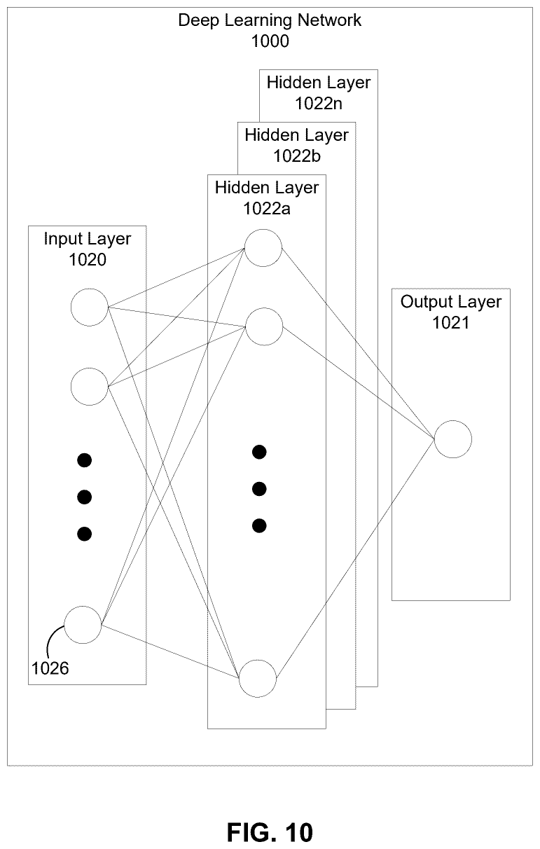

Various aspects of the present disclosure can use machine learning models or systems. FIG. 10 is an illustrative example of a deep learning neural network 1000 that can be used to implement the machine learning-based alignment prediction described herein. An input layer 1020 includes input data. In one illustrative example, the input layer 1020 can include data representing NMR data. The neural network 1000 includes multiple hidden layers 1022a, 1022b, through 1022n. The hidden layers 1022a, 1022b, through 1022n include “n” number of hidden layers, where “n” is an integer greater than or equal to one. The number of hidden layers can be made to include as many layers as needed for the given application. The neural network 1000 further includes an output layer 1021 that provides an output resulting from the processing performed by the hidden layers 1022a, 1022b, through 1022n. In one illustrative example, the output layer 1021 can provide predicted values and parameters based on the input data. The prediction can be a prediction of material properties (e.g., NMR T₂ distributions and related parameters, MICP PTS and related parameters, etc.).

The neural network 1000 is a multi-layer neural network of interconnected nodes. Each node can represent a piece of information. Information associated with the nodes is shared among the different layers and each layer retains information as information is processed. In some cases, the neural network 1000 can include a feed-forward network, in which case there are no feedback connections where outputs of the network are fed back into itself. In some cases, the neural network 1000 can include a recurrent neural network, which can have loops that allow information to be carried across nodes while reading in input.

Information can be exchanged between nodes through node-to-node interconnections between the various layers. Nodes of the input layer 1020 can activate a set of nodes in the first hidden layer 1022a. For example, as shown, each of the input nodes of the input layer 1020 is connected to each of the nodes of the first hidden layer 1022a. The nodes of the first hidden layer 1022a can transform the information of each input node by applying activation functions to the input node information. The information derived from the transformation can then be passed to and can activate the nodes of the next hidden layer 1022b, which can perform their own designated functions. Example functions include convolutional, up-sampling, data transformation, and/or any other suitable functions. The output of the hidden layer 1022b can then activate nodes of the next hidden layer, and so on. The output of the last hidden layer 1022n can activate one or more nodes of the output layer 1021, at which an output is provided. In some cases, while nodes (e.g., node 1026) in the neural network 1000 are shown as having multiple output lines, a node has a single output and all lines shown as being output from a node represent the same output value.

In some cases, each node or interconnection between nodes can have a weight that is a set of parameters derived from the training of the neural network 1000. Once the neural network 1000 is trained, it can be referred to as a trained neural network, which can be used to classify one or more activities, objects, or parameters. For example, an interconnection between nodes can represent a piece of information learned about the interconnected nodes. The interconnection can have a tunable numeric weight that can be tuned (e.g., based on a training dataset), allowing the neural network 1000 to be adaptive to inputs and able to learn as more and more data is processed.

The neural network 1000 is pre-trained to process the features from the data in the input layer 1020 using the different hidden layers 1022a, 1022b, through 1022n in order to provide the output through the output layer 1021. In an example in which the neural network 1000 is used to identify and predict values from raw data, the neural network 1000 can be trained using training data that includes both data and labeled values (e.g., NMR echo trains, NMR T₂ distributions, MICP PTS, etc.) as described herein. For instance, training data can be input into the network, with each training data having a label indicating a corresponding value.

In some cases, the neural network 1000 can adjust the weights of the nodes using a training process called backpropagation. As described herein, a backpropagation process can include a forward pass, a loss function, a backward pass, and a weight update. The forward pass, loss function, backward pass, and parameter update is performed for one training iteration. The process can be repeated for a certain number of iterations for each set of training data until the neural network 1000 is trained well enough so that the weights of the layers are accurately tuned.

For the example of predicting values and parameters based on raw data, the forward pass can include passing a raw data and corresponding experimental values through the neural network 1000. The weights are initially randomized before the neural network 1000 is trained. A

As noted above, for a first training iteration for the neural network 1000, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1000 is unable to determine low level features and thus cannot make accurate predictions. A loss function can be used to analyze error in the output. Any suitable loss function definition can be used, such as a Cross-Entropy loss. Another example of a loss function includes the mean squared error (MSE).

The loss (or error) will be high for the first training data since the actual values will be much different than the predicted output. The goal of training is to minimize the amount of loss so that the predicted output is the same as the training label. The neural network 1000 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wi−η*dL/dW, where w denotes a weight, wi denotes the initial weight, and η denotes a learning rate. The learning rate can be set to any suitable value, with a high learning rate including larger weight updates and a lower value indicating smaller weight updates.

The neural network 1000 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 1000 can include any other deep network other than a CNN, such as an autoencoder, a deep belief nets (DBNs), a Recurrent Neural Networks (RNNs), BNNs, among others.

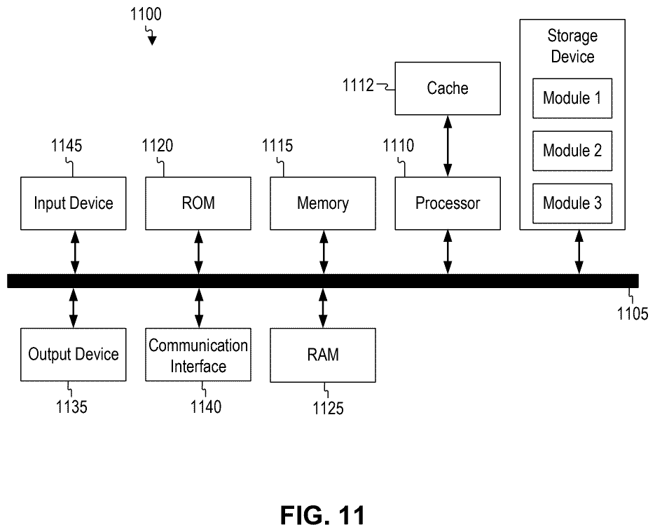

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some aspects, computing system 1100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1100 includes at least one processing unit (CPU or processor) 1110 and connection 1105 that couples various system components including system memory 1115, such as read only memory (ROM) 1120 and read only memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some aspects, a hardware service that performs a particular function can include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

The following examples are intended to be illustrative only, and are not intended to be, nor should they be construed as limiting in any way of the scope of the present disclosure.

### Example 1

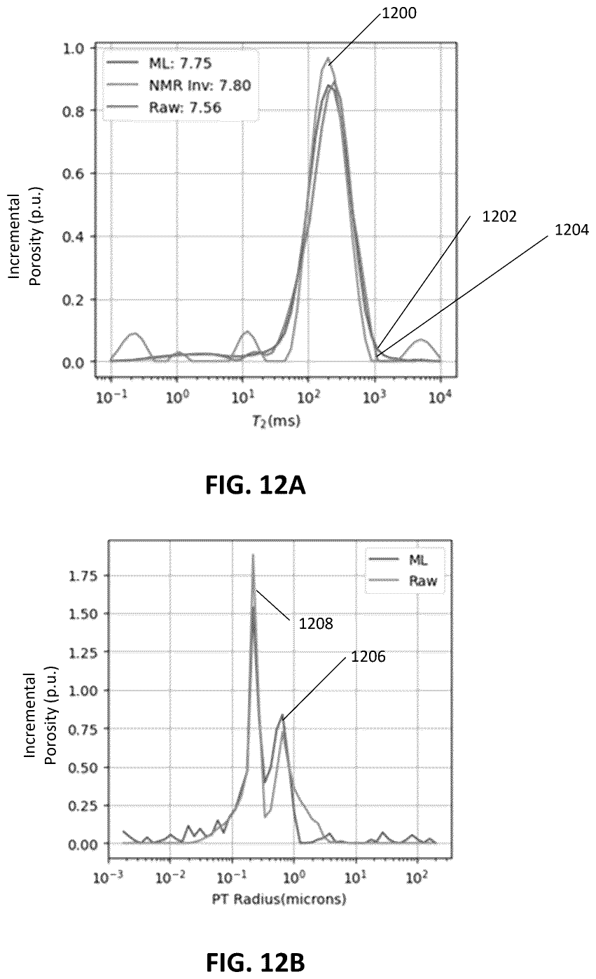

The following example illustrates training the multi-level machine learning model with 8000 samples augmented with a two core data augmentation method. FIG. 12A illustrates an example of the training results of NMR T₂ distributions of a sample for the multi-level machine learning model. The NMR T₂ distribution for the multi-level machine learning model is shown as line 1202, having a porosity of 7.75. The NMR T₂ distribution for the raw data augmented input data is shown as line 1204 having a porosity of 7.56. The NMR T₂ distribution for an NMR inverse calculation is shown by line 1200 having a porosity of 7.8. As illustrated, the multi-level machine learning model provides a more accurate NMR T₂ distribution in comparison to the raw data than the NMR inverse calculation method. The raw augmented data was used as ground truth.

FIG. 12B illustrates an example of the training results for MICP PTS of a sample for the multi-level machine learning model. The raw augmented data is shown by line 1206 while the multi-level machine learning results are illustrated by line 1208.

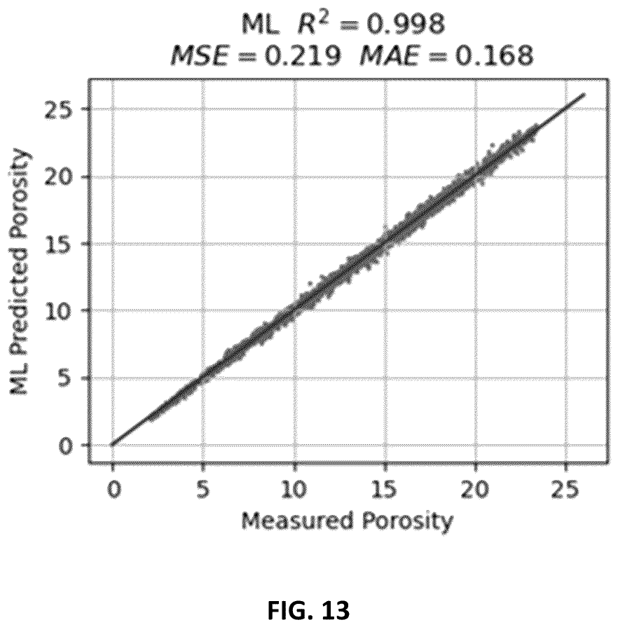

FIG. 13 illustrates a comparison of the predicted total porosities of the 8000 samples by the multi-level machine learning model and the measured total porosity of the raw data. The R² value is 0.998, the mean squared error is 0.219, and the mean absolute error is 0.168.

### Example 2

The following example describes the multi-level machine learning model performance trained with 8000 samples augmented with a two core data augmentation method as described in Example 1 and tested with 8000 samples augmented with three core data augmentation method.

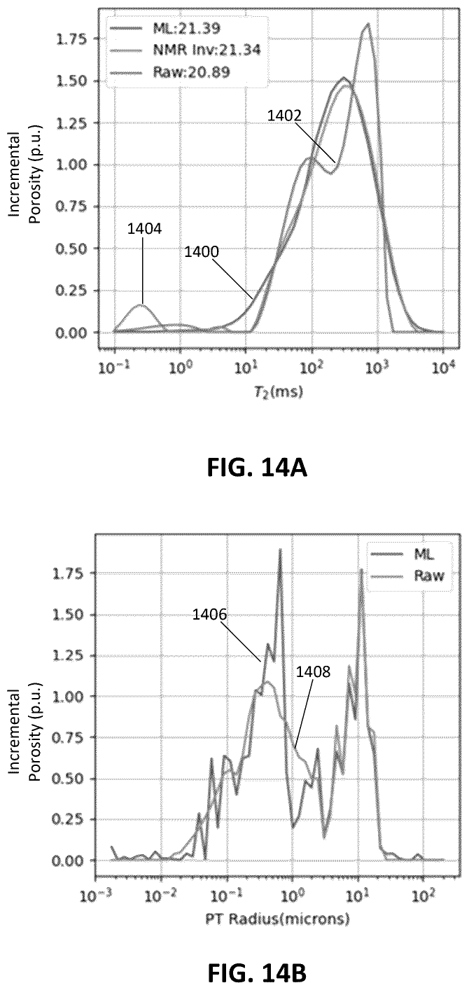

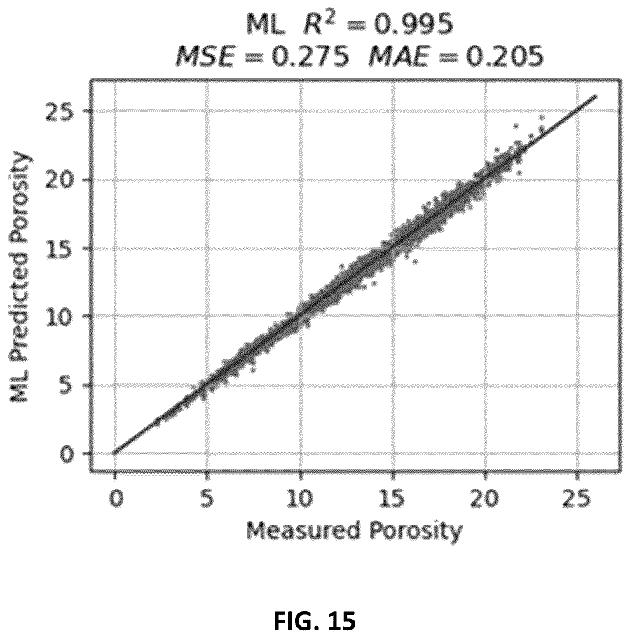

FIG. 14A illustrates an example of test results for NMR T₂ distributions of a sample for the multi-level machine learning model (line 1400) having a porosity of 21.39, the raw data (line 1402) having a porosity of 21.34, and an inverse NMR T₂ calculation (line 1404) having a porosity of 21.34. FIG. 14B illustrates an example of test results for the MICP PTS of a sample for the multi-level machine learning model (line 1406) and the raw data (line 1408). FIG. 15 illustrates a comparison of the predicted total porosities of the 8000 test samples for the multi-level machine learning model and the measured total porosities of the 8000 test samples as raw data. The R² value is 0.995, the mean squared error is 0.275, and the mean absolute error is 0.205.

### Example 3

The following example describes the multi-level machine learning model performance trained with 8000 samples augmented with a two core data augmentation method as described in Example 1 and tested with 8000 samples augmented with a single core augmentation method.

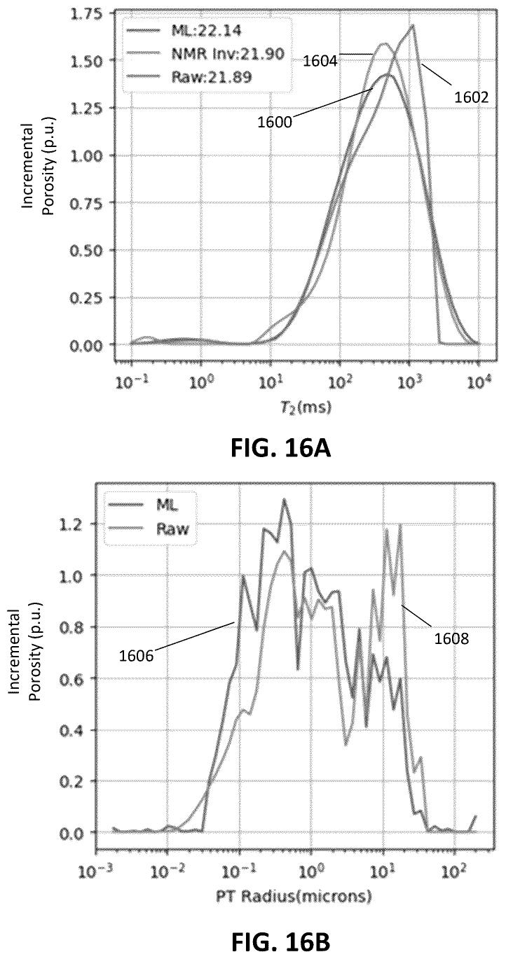

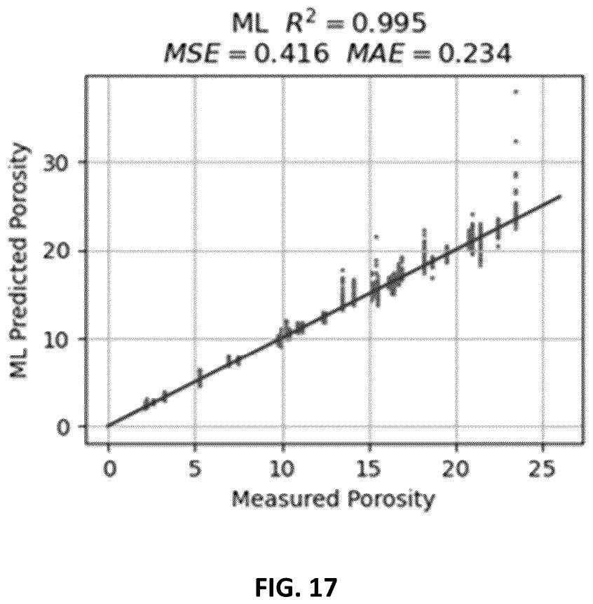

FIG. 16A illustrates an example of test results for NMR T₂ distributions of a sample for the multi-level machine learning model (line 1600) having a porosity of 22.14, the raw data (line 1602) having a porosity of 21.89, and an inverse NMR T₂ calculation (line 1604) having a porosity of 21.90. FIG. 16B illustrates an example of test results for the MICP PTS of a sample for the multi-level machine learning model (line 1606) and the raw data (line 1608). FIG. 17 illustrates a comparison of the predicted total porosities of the 8000 test samples for the multi-level machine learning model and the measured total porosities of the 8000 test samples as raw data. The R² value is 0.995, the mean squared error is 0.416, and the mean absolute error is 0.234.

Numerous examples are provided herein to enhance understanding of the present disclosure. A specific set of statements are provided as follows.

Statement 1: A computer-implemented method for transforming nuclear magnetic resonance (NMR) measurements of a sample to a pore throat size distribution and a NMR T₂ distribution using a multi-level machine learning model, the computer-implemented method comprising: transforming, via a first neural network, one or more input NMR measurements to a predicted pore throat size distribution or one or more predicted pore throat size parameters; transforming, via a second neural network, the predicted pore throat size distribution or the one or more predicted pore throat size parameters to a predicted NMR T₂ distribution or one or more predicted NMR T₂ parameters; modeling the predicted NMR T₂ distribution or the one or more predicted NMR T₂ parameters to one or more simulated NMR measurements; and determining a drilling path for a borehole or perforation interval based on the predicted pore throat size distribution, the one or more predicted pore throat size parameters, the predicted NMR T₂ distribution, and/or the one or more predicted NMR T₂ parameters.

Statement 2: A computer-implemented method as disclosed in Statement 1, wherein the one or more input NMR measurements are recorded in a time domain as echo trains.

Statement 3: A computer-implemented method as disclosed in Statement 1 or 2, wherein the one or more simulated NMR measurements are NMR response in a time domain as echo trains.

Statement 4: A computer-implemented method as disclosed in any of preceding Statements 1-3, wherein the one or more simulated NMR measurements are compared to the one or more input NMR measurements.

Statement 5: A computer-implemented method as disclosed in any of preceding Statements 1-4, wherein forward modeling the predicted NMR T₂ distributions or one or more predicted NMR T₂ distributions is utilized in a loss function.

Statement 6: A computer-implemented method as disclosed in Statement 5, wherein the loss function comprises mean square differences between the one or more simulated NMR measurements and the one or more input NMR measurements, a regularization term having 0^{th} or 2^{nd} order, and mean square differences between the predicted pore throat size distribution and a measured pore throat size distribution.

Statement 7: A computer-implemented method as disclosed in any of preceding Statements 1-6, wherein the one or more predicted pore throat size parameters comprise principal components (PCA), a Thomeer decomposition, and/or a Gaussian decomposition.

Statement 8: A computer-implemented method as disclosed in any of preceding Statements 1-7, wherein the one or more predicted NMR T₂ parameters comprise principal components and/or a Gaussian decomposition.

Statement 9: A computer-implemented method as disclosed in any of preceding Statements 1-8, wherein the computer-implemented method further comprises training the multi-level machine learning model, and wherein training the multi-level machine learning model comprises augmenting the one or more input NMR measurements with one or more noise contamination levels.

Statement 10: A computer-implemented method as disclosed in Statement 9, wherein the pore throat size distribution for the one or more input NMR measurements with the one or more noise contamination levels is constant.

Statement 11: A computer-implemented method as disclosed in Statements 9 or 10, wherein the one or more noise contamination levels comprise signal-to-noise ratios of 5, 10, 15, and 20.

Statement 12: A computer-implemented method as disclosed in any of preceding Statements 1-11, wherein the computer-implemented method further comprises training the multi-level learning model, and wherein training the multi-level machine learning model comprises randomly selecting and linearly combining one or more input variables with random ratios and linearly combining one or more target variables with the random ratios.

Statement 13: A computer-implemented method as disclosed in Statement 12, wherein if the one or more input variables and the one or more target variables have a different additive basis, the one or more input variables or the one or more target variables are converted to have the same additive basis.

Statement 14: A computer-implemented method as disclosed in Statement 13, wherein the one or more input variables are NMR T₂ distributions, and the one or more target variables are pore throat size distributions.

Statement 15: A computer-implemented method as disclosed in Statement 14, wherein training the multi-level machine learning model further comprises forward modeling a linearly combined NMR T₂ distribution to simulate NMR echo response with added noise contamination levels comprising signal-to-noise ratios of 5, 10, 15, and 20.

Statement 16: A computer-implemented method as disclosed in Statement 15, wherein a corresponding pore throat size distribution is a linearly combined pore throat size distribution for the simulated NMR echo response with the signal-to-noise ratios.

Statement 17: A computer-implemented method as disclosed in Statements 15 or 16, wherein the linearly combined NMR T₂ distribution is forward modeled with NMR 1D data acquisition schemes or NMR 2D acquisition schemes.

Statement 18: A computer-implemented method as disclosed in any of preceding Statements 1-18, the computer-implemented method further comprising determining a total porosity and a partial porosity of the sample from the predicted NMR T₂ distribution and the predicted pore throat size distribution.

Statement 19: A computer-implemented method as disclosed in Statement 19, wherein the total porosity and the partial porosity of the sample is used to determining a drilling path for a borehole or perforation interval.

Statement 20: A computer-implemented method as disclosed in any of preceding Statements 1-19, wherein the computer-implemented method is repeated for a different sample to determine the path for the borehole.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. A computer-implemented method for transforming nuclear magnetic resonance (NMR) measurements of a sample to a pore throat size distribution and a NMR T₂ distribution using a multi-level machine learning model, the computer-implemented method comprising:
transforming, via a first neural network, one or more input NMR measurements to a predicted pore throat size distribution or one or more predicted pore throat size parameters;
transforming, via a second neural network, the predicted pore throat size distribution or the one or more predicted pore throat size parameters to a predicted NMR T₂ distribution or one or more predicted NMR T₂ parameters;
modeling the predicted NMR T₂ distribution or the one or more predicted NMR T₂ parameters to one or more simulated NMR measurements; and
determining a drilling path for a borehole or perforation interval based on the predicted pore throat size distribution, the one or more predicted pore throat size parameters, the predicted NMR T₂ distribution, and/or the one or more predicted NMR T₂ parameters.

2. The computer-implemented method of claim 1, wherein the one or more input NMR measurements are recorded in a time domain as echo trains.

3. The computer-implemented method of claim 1, wherein the one or more simulated NMR measurements are NMR response in a time domain as echo trains.

4. The computer-implemented method of claim 1, wherein the one or more simulated NMR measurements are compared to the one or more input NMR measurements.

5. The computer-implemented method of claim 1, wherein forward modeling the predicted NMR T₂ distribution or one or more predicted NMR T₂ distributions is utilized in a loss function.

6. The computer-implemented method of claim 5, wherein the loss function comprises mean square differences between the one or more simulated NMR measurements and the one or more input NMR measurements, a regularization term having 0th or 2nd order, and mean square differences between the predicted pore throat size distribution and a measured pore throat size distribution.

7. The computer-implemented method of claim 1, wherein the one or more predicted pore throat size parameters comprise principal components (PCA), a Thomeer decomposition, and/or a Gaussian decomposition.

8. The computer-implemented method of claim 1, wherein the one or more predicted NMR T₂ parameters comprise principal components and/or a Gaussian decomposition.

9. The computer-implemented method of claim 1, wherein the computer-implemented method further comprises training the multi-level machine learning model, and wherein training the multi-level machine learning model comprises augmenting the one or more input NMR measurements with one or more noise contamination levels.

10. The computer-implemented method of claim 9, wherein the pore throat size distribution for the one or more input NMR measurements with the one or more noise contamination levels is constant.

11. The computer-implemented method of claim 9, wherein the one or more noise contamination levels comprise signal-to-noise ratios of 5, 10, 15, and 20.

12. The computer-implemented method of claim 1, wherein the computer-implemented method further comprises training the multi-level machine learning model, and wherein training the multi-level machine learning model comprises randomly selecting and linearly combining one or more input variables with random ratios and linearly combining one or more target variables with the random ratios.

13. The computer-implemented method of claim 12, wherein if the one or more input variables and the one or more target variables have a different additive basis, the one or more input variables or the one or more target variables are converted to have the same additive basis.

14. The computer-implemented method of claim 13, wherein the one or more input variables are NMR T₂ distributions, and the one or more target variables are pore throat size distributions.

15. The computer-implemented method of claim 14, wherein training the multi-level machine learning model further comprises forward modeling a linearly combined NMR T₂ distribution to simulate NMR echo response with added noise contamination levels comprising signal-to-noise ratios of 5, 10, 15, and 20.

16. The computer-implemented method of claim 15, wherein a corresponding pore throat size distribution is a linearly combined pore throat size distribution for the simulated NMR echo response with the signal-to-noise ratios.

17. The computer-implemented method of claim 16, wherein the linearly combined NMR T₂ distribution is forward modeled with NMR 1D data acquisition schemes or NMR 2D acquisition schemes.

18. The computer-implemented method of claim 1, the computer-implemented method further comprising determining a total porosity and a partial porosity of the sample from the predicted NMR T₂ distribution and the predicted pore throat size distribution.

19. The computer-implemented method of claim 18, wherein the total porosity and the partial porosity of the sample is used to determine the drilling path for the borehole or perforation interval.

20. The computer-implemented method of claim 1, wherein the computer-implemented method is repeated for a different sample to determine the drilling path for the borehole or perforation interval.
